(19) United States
(12) Patent Application Publication
(10) Pub. No.: US 2026/0089005 A1
(43) Pub. Date: Mar. 26, 2026

(54) ACCOUNT SECURITY MANAGEMENT ARCHITECTURE AND METHOD APPLIED TO ARTIFICIAL INTELLIGENCE SERVICE

(71) Applicants: CHI-CHING CHEN, New Taipei City (TW); Net Alliance Co., Ltd., New Taipei City (TW)

(72) Inventor: CHI-CHING CHEN, New Taipei City (TW)

(21) Appl. No.: 19/015,344

(22) Filed: Jan. 9, 2025

(30) Foreign Application Priority Data
Sep. 20, 2024 (TW) 113135866

(51) Int. Cl. H04L 9/32

(52) U.S. Cl. CPC H04L 9/3234; H04L 9/3228

(57) ABSTRACT

This disclosure provides an account security management architecture. When a user wants to log in to an AI management system, he can enter a login ID and password via a communication device. Then, the user receives a message for verifying a physical card from the AI management system via the communication device, reads an internal code from the physical card by a card reader, and sends the internal code to a supervision system via the communication device. The supervision system verifies the identity of the physical card holder based on the internal code, and sends a notification message with the identity of the physical card holder to the AI management system. If the AI management system determines that the identity of the physical card holder matches that of the current user, the communication device used by the user will be allowed to login the AI management system.

This non-provisional application claims priority claim under 35 U.S.C. § 119 (a) on Taiwan Patent Application No. 113135866 filed Sep. 20, 2024, the entire contents of which are incorporated herein by reference.

### FIELD OF THE INVENTION

The disclosure relates to an account security management architecture and method, particularly to account security management architecture and method applied to artificial intelligence service.

### BACKGROUND

With the scientific and technological development of artificial intelligence (AI), many AI technologies have been introduced into many services. Users can execute these AI services on the Internet by using their mobile phones or computers. However, more convenient AI services are often accompanied by higher security risks. Therefore, user identity authentication and identification become more important.

In order to maintain the account security of these AI services, the AI service provider will establish an AI management system to manage AI service information and user permissions. To verify the identity of the user, when the user logs in the AI management system, the AI management system usually requires the user to enter a login ID and password. Thus, the AI management system identifies the identity of the user based on the entered login ID and password to approve the user's login.

The login ID and password of the user are usually stored in the AI management system and the computer or mobile phone used by the user. In recent years, hackers have become increasingly rampant. Once hackers infiltrate the AI management system or the computer or mobile phone used by the user, the user's login ID and password will be easily stolen, which can lead to unauthorized use of AI services by hackers or malicious third parties, resulting in financial losses for users or the leakage of sensitive information.

In addition, the current account security management of AI services is independently supervised by the AI management system built by the AI service provider. The internal employees of the AI management system have the management authority of the user account. If internal controls within the AI management system are lax, the AI management system can easily obtain the login ID and password of the user account through administrative authority, enabling them to log into the AI management system as users and misuse AI services. Afterwards, it is difficult to clarify who is the actual operator of the AI services. Therefore, the identity authentication and login permission of AI service users are the sole responsibility of the AI service provider, and there may also be situations where there is confusion, leading to legal disputes.

### SUMMARY OF THE INVENTION

It is one objective of the disclosure to provide an account security management architecture applied to an artificial intelligence service. The account security management architecture includes an artificial intelligence (AI) management system, at least one physical card, a supervision system, and at least one communication device. AI management system provides at least one artificial intelligence service, and includes a management database for recording an identity of at least one AI service user and a login ID and password of at least one user account. The physical card is issued by an impartial organization, held by the AI service user, and stores an internal code. The supervision system is configured by the impartial organization, and includes a supervision database for recording an identity of at least one physical card holder and the internal code corresponding to the at least one physical card holder. When the AI service user wants to log in the AI management system, the AI service user enters the login ID and password of the corresponding user account into the AI management system through the communication device. The AI management system identifies the identity of the AI service user based on the entered login ID and password, and then sends an indicating message for verifying the physical card to the communication device and sends an indicating message for verifying the identity of the AI service user to the supervision system. After the communication device receives the indicating message for verifying the physical card, the communication device reads the internal code from the physical card via the reader and sends the internal code to the supervision system. When the supervision system receives the indicating message for verifying the identity of the AI service user from the AI management system and the internal code from the at least one communication device, the supervision system searches the identity of the physical card holder from the supervision database based on the received internal code, and checks whether the identity of the physical card holder matches the identity of the AI service user. If the identity of the physical card holder matches the identity of the AI service user, the supervision system sends a notification signal for approving the login of the AI service user to the AI management system, so as to allow the communication device used by the AI service user to log into the AI management system. On contrary, if the identity of the physical card holder does not match the identity of the AI service user, the supervision system sends a notification signal for prohibiting the login of the AI service user to the AI management system, so as to prevent the communication device used by the AI service user to log into the AI management system.

To achieve the above objective, the disclosure provide an account security management architecture, which is applied to an artificial intelligence service, including: an artificial intelligence management system, provided with the artificial intelligence service, and comprising a management database, wherein the management database records an identity of at least one user and a login ID and password of at least one user account; at least one physical card, issued by an impartial organization, and held by the at least one corresponding user, wherein the at least one physical card stores an internal code; a supervision system, configured by the impartial organization, network-connected to the artificial intelligence management system, and comprising a supervision database that records an identity of at least one physical card holder and the internal code corresponding to the at least one physical card holder; at least one communication device, network-connected to the artificial intelligence management system and the supervision system, and used by the at least one corresponding user; and at least one card reader being an internal component of the at least one communication device or an external device electrically connected to the at least one communication device; when the at least one user wants to log in the artificial intelligence management system, the at least one user enters the login ID and password of the at least one corresponding user account into the artificial intelligence management system through the at least one communication device; the artificial intelligence management system identifies the identity of the at least one user based on the entered login ID and password, and then sends an indicating message for verifying the at least one physical card to the at least one communication device and sends an indicating message for verifying the identity of the at least one user to the supervision system; after the at least one communication device receives the indicating message for verifying the at least one physical card, the at least one communication device reads the internal code from the at least one physical card via the at least one card reader and sends the internal code to the supervision system; when the supervision system receives the indicating message for verifying the identity of the at least one user from the artificial intelligence management system and the internal code from the at least one communication device, the supervision system searches the identity of the at least one physical card holder from the supervision database based on the received internal code, and checks whether the identity of the at least one physical card holder matches the identity of the at least one user; if the identity of the at least one physical card holder matches the identity of the at least one user, the supervision system sends a notification signal for approving the login of the at least one user to the artificial intelligence management system, so as to allow the at least one communication device used by the at least one user to log into the artificial intelligence management system; on contrary, if the identity of the at least one physical card holder does not match the identity of the at least one user, the supervision system sends a notification signal for prohibiting the login of the at least one user to the artificial intelligence management system, so as to prevent the at least one communication device used by the at least one user to log into the artificial intelligence management system.

In one embodiment of the disclosure, when the artificial intelligence management system receives the notification signal for approving the login of the at least one user, the artificial intelligence management system sends an indicating message including a verification code to the at least one communication device used by the at least one user; after the at least one communication device receives the indicating message including the verification code, the at least one user enters the verification code on the at least one communication device, and then the entered verification code is transmitted to the artificial intelligence management system via the at least one communication device; the artificial intelligence management system allows the login of the at least one communication device used by the at least one user after receiving the verification code returned by the at least one communication device used by the at least one user.

In one embodiment of the disclosure, wherein the verification code is a time-based one-time password.

In one embodiment of the disclosure, wherein the at least one physical card stores the internal code through a chip, an RFID tag, a near field communication tag or a magnetic strip, and the at least one card reader obtains the internal code by reading the chip, the RFID tag, the near field communication tag or the magnetic strip in the at least one physical card.

In one embodiment of the disclosure, wherein the impartial organization is a government agency unit or an impartial and independent third party unit.

The disclosure further provides an account security management architecture, which is applied to an artificial intelligence service, including: an artificial intelligence management system, provided with the artificial intelligence service, and comprising a management database, wherein the management database records an identity of at least one user and a login ID and password of at least one user account; at least one physical card, issued by an impartial organization, and held by the at least one corresponding user, wherein the at least one physical card stores an internal code; a supervision system, configured by the impartial organization, network-connected to the artificial intelligence management system, and comprising a supervision database that records an identity of at least one physical card holder and the internal code corresponding to the at least one physical card holder; at least one communication device, network-connected to the artificial intelligence management system and the supervision system, and used by the at least one corresponding user; and at least one card reader being an internal component of the at least one communication device or an external device electrically connected to the at least one communication device; when the at least one user wants to login the artificial intelligence management system, the at least one user enters the login ID and password of the at least one corresponding user account into the artificial intelligence management system through the at least one communication device; the artificial intelligence management system identifies the identity of the at least one user based on the entered login ID and password, and then sends an indicating message for verifying the at least one physical card to the at least one communication device; after the at least one communication device receives the indicating message for verifying the at least one physical card, the at least one communication device reads the internal code from the at least one physical card via the at least one card reader and sends the internal code to the supervision system; when the supervision system receives the internal code from the at least one communication device, the supervision system searches the identity of the at least one physical card holder from the supervision database based on the received internal code, and then sends a notification signal with the identity of the at least one physical card holder to the artificial intelligence management system; after receiving the notification signal with the identity of the at least one physical card holder, the artificial intelligence management system checks whether the identity of the at least one physical card holder matches the identity of the at least one user; if the identity of the at least one physical card holder matches the identity of the at least one user, the artificial intelligence management system allows the login of the at least one communication device used by the at least one user; if the identity of the at least one physical card holder does not match the identity of the at least one user, the artificial intelligence management system prevents the login of the at least one communication device used by the at least one user.

In one embodiment of the disclosure, when the artificial intelligence management system checks that the identity of the at least one physical card holder matches the identity of the at least one user, the artificial intelligence management system sends an indicating message including a verification code to the at least one communication device used by the at least one user; after the at least one communication device receives the indicating message including the verification code, the at least one user enters the verification code on the at least one communication device, and then the entered verification code is transmitted to the artificial intelligence management system via the at least one communication device; the artificial intelligence management system approves the login of the at least one communication device used by the at least one user after receiving the verification code returned by the at least one communication device used by the at least one user.

The disclosure further provides an account security management method, which is implemented in an account security management architecture including an artificial intelligence management system for providing an artificial intelligence service, a supervision system configured by an impartial organization, and at least one communication device used by at least one corresponding user, the account security management method including: building a network connection between the at least one communication device, the artificial intelligence management system and the supervision system; providing at least one physical card having an internal code to the at least one user and recording an identity of at least one physical card holder in the supervision system; requiring the at least one user to enter a login ID and password of at least one corresponding user account into the artificial intelligence management system through the at least one communication device when the at least one user wants to login the artificial intelligence management system; requiring the artificial intelligence management system to identify an identity of the at least one user based on the login ID and password entered by the at least one user through the at least one communication device; requiring the artificial intelligence management system to send an indicating message for verifying the at least one physical card to the at least one communication device and send an indicating message for verifying the identity of the at least one user to the supervision system; requiring the at least one user to read the internal code from the at least one physical card through at least one card reader and send the internal code to the supervision system after receiving the indicating message for verifying the at least one physical card through the at least one communication device; requiring the supervision system to identify the identity of the at least one physical card holder according to the internal code received from the at least one communication device; requiring the supervision system to send a notification signal for approving the login of the at least one user to the artificial intelligence management system when the supervision system checks that the identity of the at least one physical card holder matches the identity of the at least one user so that the at least one communication device used by the at least one user can be allowed to log in the artificial intelligence management system; or requiring the supervision system to send a notification signal for prohibiting the login of the at least one user to the artificial intelligence management system when the supervision system checks that the identity of the at least one physical card holder does not match the identity of the at least one user so as to prevent the at least one communication device used by the at least one user to log in the artificial intelligence management system.

In one embodiment of the disclosure, after the artificial intelligence management system receiving the notification signal for approving the login of the at least one user, the account security management method further including: requiring the artificial intelligence management system to send an indicating message including a verification code to the at least one communication device used by the at least one user; requiring the at least one user to enter the verification code on the at least one communication device after receiving the indicating message including the verification code through the at least one communication device and transmitting the entered verification code to the artificial intelligence management system through the at least one communication device; and requiring the artificial intelligence management system to allow the login of the at least one communication device used by the at least one user after receiving the verification code returned by the at least one communication device used by the at least one user.

The disclosure further provides an account security management method, which is implemented in an account security management architecture including an artificial intelligence management system for providing an artificial intelligence service, a supervision system configured by an impartial organization, and at least one communication device used by at least one corresponding user, the account security management method including: building a network connection between the at least one communication device, the artificial intelligence management system and the supervision system; providing at least one physical card having an internal code to the at least one user and recording an identity of at least one physical card holder in the supervision system; requiring the at least one user to enter a login ID and password of at least one corresponding user account into the artificial intelligence management system through the at least one communication device when the at least one user wants to login the artificial intelligence management system; requiring the artificial intelligence management system to identify an identity of the at least one user based on the login ID and password entered by the at least one user through the at least one communication device; requiring the artificial intelligence management system to send an indicating message for verifying the at least one physical card to the at least one communication device; requiring the at least one user to read the internal code from the at least one physical card through at least one card reader and send the internal code to the supervision system after receiving the indicating message for verifying the at least one physical card through the at least one communication device; requiring the supervision system to identify the identity of the at least one physical card holder according to the internal code received from the at least one communication device; requiring the supervision system to send a notification signal with the identity of the at least one physical card holder to the artificial intelligence management system; requiring the artificial intelligence management system to check whether the identity of the at least one physical card holder matches the identity of the at least one user after receiving the notification signal with the identity of the at least one physical card holder; requiring the artificial intelligence management system to allow the login of the at least one communication device used by the at least one user if the identity of the at least one physical card holder matches the identity of the at least one user; or requiring the artificial intelligence management system to prevent the login of the at least one communication device used by the at least one user if the identity of the physical card holder does not match the identity of the at least one user.

In one embodiment of the disclosure, after the artificial intelligence management system checks that the identity of the at least one physical card holder matches the identity of the at least one user, the account security management method further including: requiring the artificial intelligence management system to send an indicating message including a verification code to the at least one communication device used by the at least one user; requiring the at least one user to enter the verification code on the at least one communication device after receiving the indicating message including the verification code through the at least one communication device and transmitting the entered verification code to the artificial intelligence management system through the at least one communication device; and requiring the artificial intelligence management system to allow the login of the at least one communication device used by the at least one user after receiving the verification code returned by the at least one communication device used by the at least one user.

The advantages of the account security management mechanism of the present disclosure are as follows: (1). when the user wants to log in to the AI management system, in addition to entering the correct login ID and password of the corresponding user account, the user must further pass the identity verification of the physical card held by the user through the supervision system, thereby enhancing the account security of the AI management system through dual identity verification; (2). by adding the identity verification of the physical card as a prerequisite for logging in to the AI management system, even if the login ID and password of the user account are stolen because of hacking of the AI management system or the communication device, network hackers or malicious third parties cannot also directly log in to the AI management system by using the stolen login ID and password, thereby safeguarding the account security of the AI management system; (3). the AI management system only provides the AI service, while the user's permission to log in to the AI management system is transferred from the original AI management system to the impartial and independent supervision system so as to reduce the risk of the user's AI service being misused by unauthorized parties.

### BRIEF DESCRIPTION OF THE DRAWINGS

FIG. 1 is a schematic diagram of account security management architecture according to one embodiment of the present disclosure.

FIG. 2 is a flowchart of account security management method according to one embodiment of the present disclosure.

FIG. 3 is a flowchart of account security management method according to another embodiment of the present disclosure.

FIG. 4 is a schematic diagram of account security management architecture according to another embodiment of the present disclosure.

FIG. 5 is a flowchart of account security management method according to another embodiment of the present disclosure.

FIG. 6 is a flowchart of account security management method according to another embodiment of the present disclosure.

### DETAILED DESCRIPTION OF THE PREFERRED EMBODIMENTS

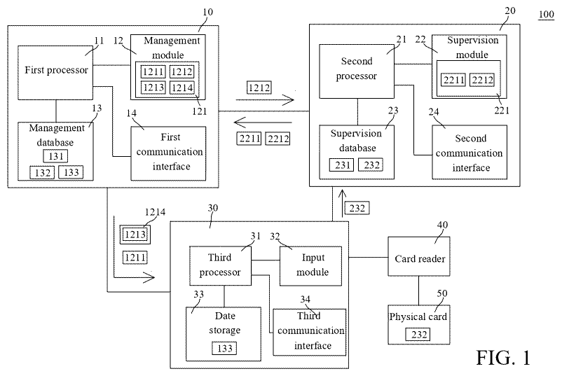

Referring to FIG. 1, there is shown a schematic diagram of account security management architecture according to one embodiment of the present disclosure. As shown in FIG. 1, the account security management architecture 100 is applied to artificial intelligence (AI) service, and includes an AI management system 10, a supervision system 20, and at least one communication device 30.

The AI management system 10 is a network server established by an AI service provider, and provided with at least one AI service, such as AI financial trading, AI digital asset trading, AI online shopping, AI automated manufacturing, or other applications that introduce AI technology. The AI management system 10 includes a first processor 11, a management module 12, a management database 13, and a first communication interface 14. The first processor 11 is electrically connected to the management module 12, the management database 13, and the first communication interface 14. The management module 12 is a memory component (such as non-volatile memory or read-only memory) for storing at least one AI management procedure 121. The AI management procedure 121 can be a type of software or firmware. In the present disclosure, the AI management system 10 can execute the AI management procedure 121 of the management module 12 through the first processor 11 so as to manage AI service information, identify or verify the identity of AI service users, or set the access permissions for AI service users. The management database 13 stores at least one data 131 required for AI service, records an identity 132 of at least one user (such as the user's name, gender, phone number, email, etc.) and a login ID and password 133 for at least one user account. In the present disclosure, the login ID and password 133 for the user account can consist of text, numbers, a combination of text and numbers, or biometric characteristics (such as fingerprints, facial recognition, or iris images).

The supervision system 20 is a network server established by an impartial organization, and used to supervise the identity of AI service users. The impartial organization is a government agency unit or an impartial and independent third-party unit (such as a foundation approved by the government and related to the supervision of information security). The supervision system 20 includes a second processor 21, a supervision module 22, a supervision database 23, and a second communication interface 24. The second processor 21 is electrically connected to the supervision module 22, the supervision database 23, and the second communication interface 24. The supervision system 20 is network-connected to the first communication interface 14 of the AI management system 10 through the second communication interface 24 to transmit information between the AI management system 10 and the supervision system 20. The supervision module 22 is a memory component for storing a procedure 221 for supervising the identity of AI service user. The procedure 221 for supervising an identity of AI service user can be a type of software or firmware. In the present disclosure, the supervision system 20 can execute the procedure 221 in the supervision module 22 through the second processor 21 to supervise the identity of the user of the AI management system 10.

For achieving the purpose of supervising the identity of AI service users, the impartial organization of the present disclosure can issue a physical card 50 for identifying the user's identity to each AI service user of the AI management system 10. The physical card 50 includes an internal code 232. The internal code 232 is a unique code. The physical card 50 can store the internal code 232 through a chip, an RFID tag, a near field communication tag or a magnetic strip. Accordingly, the supervision database 23 of the supervision system 20 records the identity 231 of at least one physical card holder (such as the physical card holder's name, gender, phone number, email, etc.), along with the internal code 232 corresponding to each physical card holder.

The communication device 30 can be a computer, a mobile phone or an electronic device with Internet access, which is controlled by the AI service user. The communication device 30 includes a third processor 31, an input module 32, a data storage 33, and a third communication interface 34. The third processor 31 is electrically connected to the input module 32, the data storage 33, and the third communication interface 34. The communication device 30 is network-connected to the first communication interface 14 of the AI management system 10 and the second communication interface 24 of the supervision system 20 through the third communication interface 34 to transmit information between the AI management system 10, the supervision system 20, and the communication device 30. The user can log in the AI management system 10 through the communication device 30 so as to use the AI service provided by the AI management system 10. The input module 32 can be a keyboard, a touch pad, a touch screen, a fingerprint key, an image capture device, or a device capable of entering text, numbers or patterns. The data storage 33 is used to store data generated by executing AI service. Furthermore, the data storage 33 can stores the login ID and password 133 required for the user to log in to the user account of the AI management system 10.

The account security management architecture 100 further includes at least one card reader 40. In one embodiment of the present disclosure, the card reader 40 can also be an external device; the communication device 30 is connected to the card reader 40 through a connection port (not shown). Alternatively, in another embodiment of the present invention, the card reader 40 can also be an internal chip of the communication device 30; the third processor 31 is electrically connected to the card reader 40. In the present disclosure, the card reader 40 obtains the internal code 232 by reading the chip, the RFID tag, the near field communication (NFC) tag or the magnetic strip in the physical card 50.

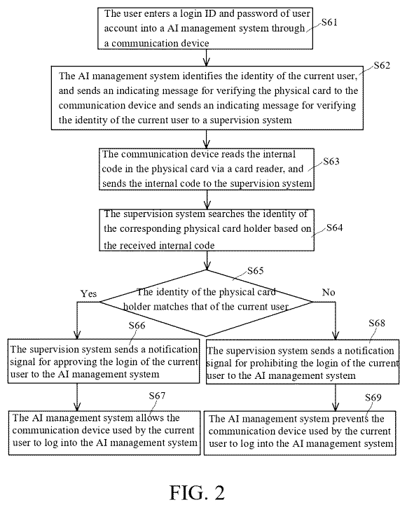

Referring to FIG. 1 and FIG. 2 at the same time, the specific operation process of one embodiment of the account security management method of the present disclosure is explained as follows: firstly, in step S61, when the user wants to log in to the AI management system 10, the communication device 30 used by the user is network-connected to the AI management system 10, and the user enters the login ID and password 133 of the user account into a login page (not shown) of the AI management system 10 through the input module 32 of the communication device 30.

In step S62, the AI management system 10 identifies the identity 132 of the current user from the management database 13 based on the entered login ID and password 133 of the user account, and sends an indicating message 1211 for verifying the physical card 50 to the communication device 30 and sends an indicating message 1212 for verifying the identity 132 of the current user to the supervision system 20.

In step S63, after the user receives the indicating message 1211 for verifying the physical card 50 through the communication device 30, the user uses the card reader 40 to read the internal code 232 in the physical card 50, and then sends the internal code 232 to the supervision system 20 through the communication device 30.

In step S64, when the supervision system 20 receives the indicating message 1212 for verifying the identity 132 of the current user from the AI management system 10 and receives the internal code 232 from the communication device 30, the supervision system 20 searches the identity 231 of the corresponding physical card holder from the supervision database 23 based on the received internal code 232. In the present disclosure, the internal code 232 stored in the physical card 50 is a ciphertext internal code generated through an encryption algorithm. When the supervisory system 20 receives the internal code 232 from the communication device 30, the supervisory system 20 must perform a decryption operation to the ciphertext internal code 232 so as to obtain a plaintext internal code.

In step S65, the supervision system 20 checks whether the identity 231 of the physical card holder matches the identity 132 of the current user. If the identity 231 of the physical card holder matches the identity 132 of the current user, it means that the current user has successfully passed the identity verification, then the step S66 is executed, and the supervision system 20 sends a notification signal 2211 for approving the login of the current user to the AI management system 10. In step S67, after the AI management system 10 receives the notification signal 2211 for approving the login of the current user, the AI management system 10 allows the communication device 30 used by the current user to log into the AI management system 10. On the contrary, if the identity 231 of the physical card holder does not match the identity 132 of the current user, it means that the current user has not passed the identity verification, then the step S68 is executed, and the supervision system 20 sends a notification signal 2212 for prohibiting the login of the current user to the AI management system 10. In step S69, after the AI management system 10 receives notification signal 2212 for prohibiting the login of the current user, the AI management system 10 will prevent the communication device 30 used by the current user to log into the AI management system 10.

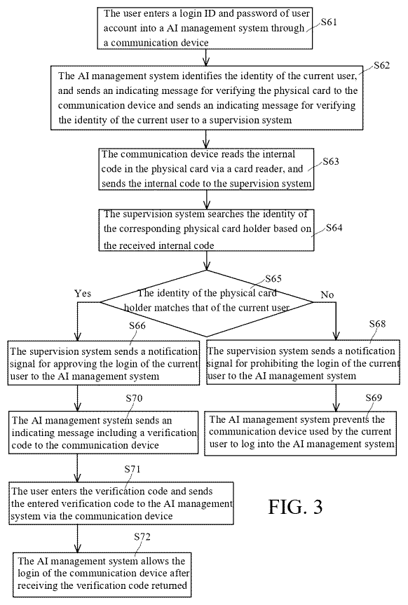

Referring to FIG. 1 and FIG. 3, in another embodiment of the present disclosure, steps S70, S71, and S72 will be executed after step S66 has been executed. In step S70, after receiving the notification signal 2211 for approving the login of the current user, the AI management system 10 will send an indicating message 1214 including a verification code 1213 to the communication device 30. In the present disclosure, the verification code 1213 is a time-based one-time password, which is obtained by the first processor 11 executing the operation of One-Time Password (OTP) algorithm in the AI management procedure 121. In step S71, after the communication device 30 receives the indicating message 1214 including the verification code 1213, the user of the communication device 30 enters the verification code 1213 via the input module 32 of the communication device 30 and sends the entered verification code 1213 to the AI management system 10. In step S72, the AI management system 10 allows the login of the communication device 30 used by the user after receiving the verification code 1213 returned.

Accordingly, the advantages of the account security management mechanism of the present disclosure are as follows: (1). when the user wants to log in to the AI management system 10, in addition to entering the correct login ID and password 133 of the user account, the user must further pass the identity verification of the physical card holder, thereby enhancing the account security of the AI management system 10 through dual identity verification; (2). by adding the identity verification of the physical card holder as a prerequisite for logging in to the AI management system 10, even if the login ID and password 133 of the user account are stolen because of hacking of the AI management system 10 or the communication device 30, network hackers or malicious third parties cannot also directly log in to the AI management system 10 by using the stolen login ID and password 133, thereby safeguarding the account security of the AI management system 10; (3). the AI management system 10 only provides the AI service, while the user's permission to log in to the AI management system 10 is s transferred from the original AI management system 10 to the impartial and independent supervision system 20 so as to reduce the risk of the user's AI service being misused by unauthorized parties.

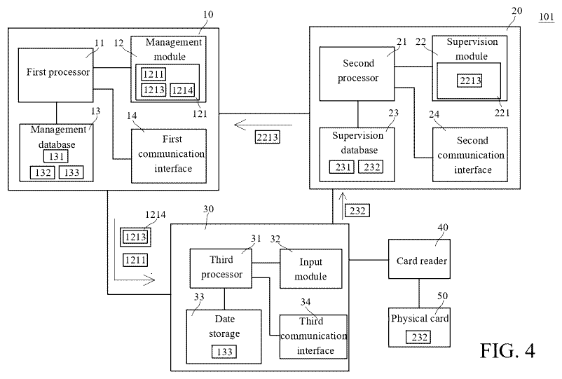

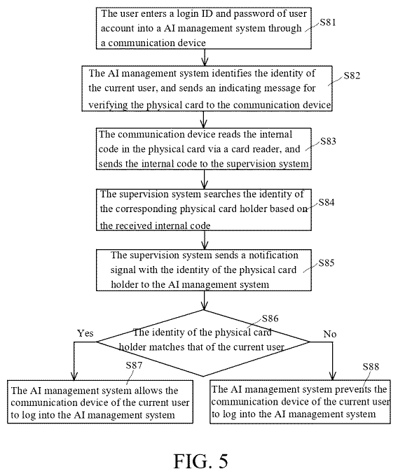

Referring to FIG. 4 and FIG. 5, there are shown a schematic diagram of account security management architecture and a flowchart of account security management method according to another embodiment of the present disclosure. The structure of the account security management architecture 101 in this embodiment is the same as that of the account security management architecture 100 in the previous embodiment. The difference between the two is that the operation procedure of account security management is partially different.

Referring to FIG. 4 and FIG. 5 at the same time, the specific operation process of another embodiment of the account security management method of the present disclosure is explained as follows: firstly, in step S81, when the user wants to log in to the AI management system 10, the communication device 30 used by the user is network-connected to the AI management system 10, and the user enters the login ID and password 133 of the user account into a login page (not shown) of the AI management system 10 through the input module 32 of the communication device 30.

In step S82, the AI management system 10 identifies the identity 132 of the current user from the management database 13 based on the entered login ID and password 133 of the user account, and sends an indicating message 1211 for verifying the physical card 50 to the communication device 30.

In step S63, after the communication device 30 receives the indicating message 1211 for verifying the physical card 50, the user uses the card reader 40 to read the internal code 232 in the physical card 50, and then sends the internal code 232 to the supervision system 20 through the communication device 30.

In step S84, after the supervision system 20 receives the internal code 232 from the communication device 30, it will search the identity 231 of the corresponding physical card holder from the supervision database 23 based on the received internal code 232. Then, in step S85, the supervision system 20 sends a notification signal 2213 with the identity 231 of the physical card holder to the AI management system 10.

In step S86, after receiving the notification signal 2213 with the identity 231 of the physical card holder from the supervision system 20, the AI management system 10 checks whether the identity 231 of the physical card holder matches the identity 132 of the current user. If the identity 231 of the physical card holder matches the identity 132 of the current user, the step S87 will be executed, the AI management system 10 allows the communication device 30 used by the current user to log into the AI management system 10. On the contrary, if the identity 231 of the physical card holder does not match the identity 132 of the current user, the step S88 will be executed, the AI management system 10 will prevent the communication device 30 used by the current user to log into the AI management system 10.

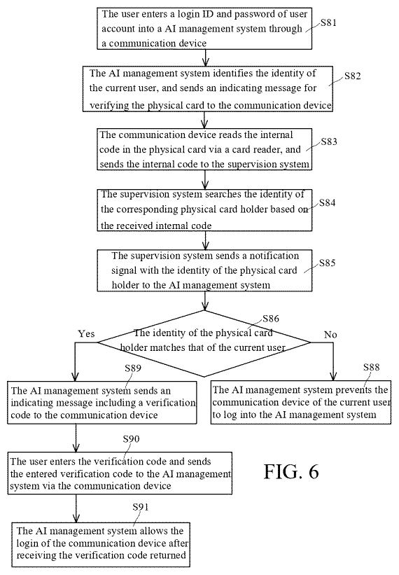

Referring to FIG. 4 and FIG. 6, in another embodiment of the present disclosure, in step S86, if the AI management system 10 checks that the identity 231 of the physical card holder matches the identity 132 of the current user, it will proceed to execute steps S89, S90, and S91. In step S89, the AI management system 10 sends an indicating message 1214 including a verification code 1213 to the communication device 30. In step S90, when the communication device 30 receives the indicating message 1214 including the verification code 1213, the user of the communication device 30 enters the verification code 1213 via the input module 32 of and sends the entered verification code 1213 to the AI management system 10 through the communication device 30. In step S91, the AI management system 10 allows the login of the communication device 30 used by the user after receiving the verification code 1213 returned.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. An account security management architecture, which is applied to an artificial intelligence service, including:
an artificial intelligence management system, provided with the artificial intelligence service, and comprising a management database, wherein the management database records an identity of at least one user and a login ID and password of at least one user account;
at least one physical card, issued by an impartial organization, and held by the at least one corresponding user, wherein the at least one physical card stores an internal code;
a supervision system, configured by the impartial organization, network-connected to the artificial intelligence management system, and comprising a supervision database that records an identity of at least one physical card holder and the internal code corresponding to the at least one physical card holder;
at least one communication device, network-connected to the artificial intelligence management system and the supervision system, and used by the at least one corresponding user; and
at least one card reader being an internal component of the at least one communication device or an external device electrically connected to the at least one communication device;
when the at least one user wants to log in the artificial intelligence management system, the at least one user enters the login ID and password of the at least one corresponding user account into the artificial intelligence management system through the at least one communication device; the artificial intelligence management system identifies the identity of the at least one user based on the entered login ID and password, and then sends an indicating message for verifying the at least one physical card to the at least one communication device and sends an indicating message for verifying the identity of the at least one user to the supervision system; after the at least one communication device receives the indicating message for verifying the at least one physical card, the at least one communication device reads the internal code from the at least one physical card via the at least one card reader and sends the internal code to the supervision system; when the supervision system receives the indicating message for verifying the identity of the at least one user from the artificial intelligence management system and the internal code from the at least one communication device, the supervision system searches the identity of the at least one physical card holder from the supervision database based on the received internal code, and checks whether the identity of the at least one physical card holder matches the identity of the at least one user; if the identity of the at least one physical card holder matches the identity of the at least one user, the supervision system sends a notification signal for approving the login of the at least one user to the artificial intelligence management system, so as to allow the at least one communication device used by the at least one user to log into the artificial intelligence management system; on contrary, if the identity of the at least one physical card holder does not match the identity of the at least one user, the supervision system sends a notification signal for prohibiting the login of the at least one user to the artificial intelligence management system, so as to prevent the at least one communication device used by the at least one user to log into the artificial intelligence management system.

2. The account security management architecture according to claim 1, when the artificial intelligence management system receives the notification signal for approving the login of the at least one user, the artificial intelligence management system sends an indicating message including a verification code to the at least one communication device used by the at least one user; after the at least one communication device receives the indicating message including the verification code, the at least one user enters the verification code on the at least one communication device, and then the entered verification code is transmitted to the artificial intelligence management system via the at least one communication device; the artificial intelligence management system allows the login of the at least one communication device used by the at least one user after receiving the verification code returned by the at least one communication device used by the at least one user.

3. The account security management architecture according to claim 2, wherein the verification code is a time-based one-time password.

4. The account security management architecture according to claim 1, wherein the at least one physical card stores the internal code through a chip, an RFID tag, a near field communication tag or a magnetic strip, and the at least one card reader obtains the internal code by reading the chip, the RFID tag, the near field communication tag or the magnetic strip in the at least one physical card.

5. The account security management architecture according to claim 1, wherein the impartial organization is a government agency unit or an impartial and independent third party unit.

6. An account security management architecture, which is applied to an artificial intelligence service, including:
an artificial intelligence management system, provided with the artificial intelligence service, and comprising a management database, wherein the management database records an identity of at least one user and a login ID and password of at least one user account;
at least one physical card, issued by an impartial organization, and held by the at least one corresponding user, wherein the at least one physical card stores an internal code;
a supervision system, configured by the impartial organization, network-connected to the artificial intelligence management system, and comprising a supervision database that records an identity of at least one physical card holder and the internal code corresponding to the at least one physical card holder;
at least one communication device, network-connected to the artificial intelligence management system and the supervision system, and used by the at least one corresponding user; and
at least one card reader being an internal component of the at least one communication device or an external device electrically connected to the at least one communication device;
when the at least one user wants to login the artificial intelligence management system, the at least one user enters the login ID and password of the at least one corresponding user account into the artificial intelligence management system through the at least one communication device; the artificial intelligence management system identifies the identity of the at least one user based on the entered login ID and password, and then sends an indicating message for verifying the at least one physical card to the at least one communication device; after the at least one communication device receives the indicating message for verifying the at least one physical card, the at least one communication device reads the internal code from the at least one physical card via the at least one card reader and sends the internal code to the supervision system; when the supervision system receives the internal code from the at least one communication device, the supervision system searches the identity of the at least one physical card holder from the supervision database based on the received internal code, and then sends a notification signal with the identity of the at least one physical card holder to the artificial intelligence management system; after receiving the notification signal with the identity of the at least one physical card holder, the artificial intelligence management system checks whether the identity of the at least one physical card holder matches the identity of the at least one user; if the identity of the at least one physical card holder matches the identity of the at least one user, the artificial intelligence management system allows the login of the at least one communication device used by the at least one user; if the identity of the at least one physical card holder does not match the identity of the at least one user, the artificial intelligence management system prevents the login of the at least one communication device used by the at least one user.

7. The account security management architecture according to claim 6, when the artificial intelligence management system checks that the identity of the at least one physical card holder matches the identity of the at least one user, the artificial intelligence management system sends an indicating message including a verification code to the at least one communication device used by the at least one user; after the at least one communication device receives the indicating message including the verification code, the at least one user enters the verification code on the at least one communication device, and then the entered verification code is transmitted to the artificial intelligence management system via the at least one communication device; the artificial intelligence management system approves the login of the at least one communication device used by the at least one user after receiving the verification code returned by the at least one communication device used by the at least one user.

8. The account security management architecture according to claim 7, wherein the verification code is a time-based one-time password.

9. The account security management architecture according to claim 6, wherein the at least one physical card stores the internal code through a chip, an RFID tag, a near field communication tag or a magnetic strip, and the at least one card reader obtains the internal code by reading the chip, the RFID tag, the near field communication tag or the magnetic strip in the at least one physical card.

10. The account security management architecture according to claim 6, wherein the impartial organization is a government agency unit or an impartial and independent third party unit.

11. An account security management method, which is implemented in an account security management architecture including an artificial intelligence management system for providing an artificial intelligence service, a supervision system configured by an impartial organization, and at least one communication device used by at least one corresponding user, the account security management method including:
building a network connection between the at least one communication device, the artificial intelligence management system and the supervision system;
providing at least one physical card having an internal code to the at least one user and recording an identity of at least one physical card holder in the supervision system;
requiring the at least one user to enter a login ID and password of at least one corresponding user account into the artificial intelligence management system through the at least one communication device when the at least one user wants to login the artificial intelligence management system;
requiring the artificial intelligence management system to identify an identity of the at least one user based on the login ID and password entered by the at least one user through the at least one communication device;
requiring the artificial intelligence management system to send an indicating message for verifying the at least one physical card to the at least one communication device and send an indicating message for verifying the identity of the at least one user to the supervision system;
requiring the at least one user to read the internal code from the at least one physical card through at least one card reader and send the internal code to the supervision system after receiving the indicating message for verifying the at least one physical card through the at least one communication device;
requiring the supervision system to identify the identity of the at least one physical card holder according to the internal code received from the at least one communication device;
requiring the supervision system to send a notification signal for approving the login of the at least one user to the artificial intelligence management system when the supervision system checks that the identity of the at least one physical card holder matches the identity of the at least one user so that the at least one communication device used by the at least one user can be allowed to log in the artificial intelligence management system; or
requiring the supervision system to send a notification signal for prohibiting the login of the at least one user to the artificial intelligence management system when the supervision system checks that the identity of the at least one physical card holder does not match the identity of the at least one user so as to prevent the at least one communication device used by the at least one user to log in the artificial intelligence management system.

12. The account security management method according to claim 11, after the artificial intelligence management system receiving the notification signal for approving the login of the at least one user, the account security management method further including:
requiring the artificial intelligence management system to send an indicating message including a verification code to the at least one communication device used by the at least one user;
requiring the at least one user to enter the verification code on the at least one communication device after receiving the indicating message including the verification code through the at least one communication device and transmitting the entered verification code to the artificial intelligence management system through the at least one communication device; and
requiring the artificial intelligence management system to allow the login of the at least one communication device used by the at least one user after receiving the verification code returned by the at least one communication device used by the at least one user.

13. The account security management method according to claim 12, wherein the verification code is a time-based one-time password.

14. An account security management method, which is implemented in an account security management architecture including an artificial intelligence management system for providing an artificial intelligence service, a supervision system configured by an impartial organization, and at least one communication device used by at least one corresponding user, the account security management method including:
building a network connection between the at least one communication device, the artificial intelligence management system and the supervision system;
providing at least one physical card having an internal code to the at least one user and recording an identity of at least one physical card holder in the supervision system;
requiring the at least one user to enter a login ID and password of at least one corresponding user account into the artificial intelligence management system through the at least one communication device when the at least one user wants to login the artificial intelligence management system;
requiring the artificial intelligence management system to identify an identity of the at least one user based on the login ID and password entered by the at least one user through the at least one communication device;
requiring the artificial intelligence management system to send an indicating message for verifying the at least one physical card to the at least one communication device;
requiring the at least one user to read the internal code from the at least one physical card through at least one card reader and send the internal code to the supervision system after receiving the indicating message for verifying the at least one physical card through the at least one communication device;
requiring the supervision system to identify the identity of the at least one physical card holder according to the internal code received from the at least one communication device;
requiring the supervision system to send a notification signal with the identity of the at least one physical card holder to the artificial intelligence management system;
requiring the artificial intelligence management system to check whether the identity of the at least one physical card holder matches the identity of the at least one user after receiving the notification signal with the identity of the at least one physical card holder;
requiring the artificial intelligence management system to allow the login of the at least one communication device used by the at least one user if the identity of the at least one physical card holder matches the identity of the at least one user; or
requiring the artificial intelligence management system to prevent the login of the at least one communication device used by the at least one user if the identity of the physical card holder does not match the identity of the at least one user.

15. The account security management method according to claim 14, after the artificial intelligence management system checks that the identity of the at least one physical card holder matches the identity of the at least one user, the account security management method further including:
requiring the artificial intelligence management system to send an indicating message including a verification code to the at least one communication device used by the at least one user;
requiring the at least one user to enter the verification code on the at least one communication device after receiving the indicating message including the verification code through the at least one communication device and transmitting the entered verification code to the artificial intelligence management system through the at least one communication device; and
requiring the artificial intelligence management system to allow the login of the at least one communication device used by the at least one user after receiving the verification code returned by the at least one communication device used by the at least one user.

16. The account security management method according to claim 15, wherein the verification code is a time-based one-time password.
